(19) United States
(12) Patent Application Publication
(10) Pub. No.: US 2024/0095861 A1
(43) Pub. Date: Mar. 21, 2024

(54) System and Method of Editing and Proofing an Election Ballot

(71) Applicant: Staci Howard, Murfreesboro, TN (US)

(72) Inventor: Staci Howard, Murfreesboro, TN (US)

(21) Appl. No.: 18/370,854

(22) Filed: Sep. 20, 2023

Related U.S. Application Data
(60) Provisional application No. 63/376,304, filed on Sep. 20, 2022.

(51) Int. Cl. G06Q 50/26

(52) U.S. Cl. CPC G06Q 50/26; G06Q 2230/00

(57) ABSTRACT

A system and a method of editing and proofing an election ballot automates the ballot proofing process to enable elected officials to be more efficient during the election preparation efforts. An overall process of the method begins by prompting an administrator account to enter ballot drafting notes. The ballot drafting notes are then relayed to a vendor account. The vendor account is then prompted to enter a ballot proof in accordance to the ballot drafting notes. The ballot proof is then relayed to the administrator account. The ballot proof is outputted, and the administrator account is then prompted to initiate a review process for the ballot proof. The review process is then managed for the ballot proof between the administrator account and the vendor account. Further, the review process is repeated until an administrator completion confirmation for the ballot proof is received from the administrator account.

The current application claims a priority to the U.S. provisional patent application Ser. No. 63/376,304 filed on Sep. 20, 2022.

### FIELD OF THE INVENTION

The present invention relates to voting systems and software. More specifically, the present invention provides means that enable the automated review of election-related documents in an efficient, accurate, and confident manner that eliminates human errors.

### BACKGROUND OF THE INVENTION

Voting in elections is a key feature of many democracies around the world. Generally, a ballot is used in the election process to enable the voting to be secret and anonymous, which ensures that the election process is carried out in a fair and secure manner. Ballots can include various information regarding the corresponding election to help the voter know who or what the individual is voting on. Thus, the information on each ballot must be presented accurately and correctly. This requires election officials to review every ballot to prevent a skewed ballot system. Unfortunately, the current ballot proofing procedure in many jurisdictions is done manually by local election officials. This manual process is susceptible to human error and causes the election officials undue stress as they review each ballot line by line and word by word before signing off on its accuracy and legitimacy. More than 10,000 elections are held in an average year in the United States. More than half a million elected officials in the U.S. encompass more than 3,000 counties and 19,000 cities and towns. Therefore, there is a need for an automated solution that removes the human error from the ballot proofing process to enable the generation of accurate official election ballots.

An objective of the present invention is to provide a system and a method of editing and proofing an election ballot. The present invention enables the custom review of documents in a more efficient, accurate, and confident manner without the concern of human error. Another objective of the present invention is to provide a system and a method of editing and proofing an election ballot that enables the secure communication between election officials and the corresponding vendors during the ballot proofing process. Another objective of the present invention is to provide a system and a method of editing and proofing an election ballot that enables candidates participating in an election to participate in the ballot proofing process to increase the transparency and accuracy of the process. Additional features and benefits of the present invention are further discussed in the sections below.

### SUMMARY OF THE INVENTION

The present invention provides a system and a method of editing and proofing an election ballot. The present invention streamlines the ballot proofing process to allow election officials to participate in the election preparation process more confidently. The present invention enables the appropriate parties to participate in the ballot proofing process at the appropriate steps during the process. In the preferred embodiment, the present invention allows elected officials to prepare ballot data before an election that can include, but is not limited to, type of election (e.g., general, primary, or special), race and/or contests, candidates/questions, polling locations, etc. In addition, the present invention includes an automated proofing process that analyses the ballot data in order to find and highlight errors or formatting issues. Further, the present invention facilitates the candidates' involvement to sign off on ballot proof to ensure their name is correct and in correct district. Furthermore, the present invention can integrate machine learning to allow showcasing of errors across other jurisdictions, chat amongst administrators, open to other organizations for petitions, ballot samples (consolidated), logic and accuracy management, absentee ballot estimator, etc.

### BRIEF DESCRIPTION OF THE DRAWINGS

FIG. 1 is a block diagram showing the system of the present invention.

FIG. 2 is a flowchart showing an overall method of the present invention.

FIG. 3 is a flowchart showing a continuation of FIG. 2.

FIG. 4 is a flowchart illustrating the subprocess of recording the tasks performed during the automated ballot proof review.

FIG. 5 is a flowchart illustrating the subprocess of requesting updated ballot proofs to fix errors found by the automated review process.

FIG. 6 is a flowchart illustrating the subprocess of providing ballot templates to the elected officials.

FIG. 7 is a flowchart illustrating the subprocess of guiding the completion of a ballot template with input boxes.

FIG. 8 is a flowchart illustrating the subprocess of involving the candidates in the ballot proofing.

FIG. 9 is a flowchart illustrating the subprocess of including the appropriate candidates in the ballot proofing.

FIG. 10 is a flowchart illustrating the subprocess of requesting ballot corrections by the candidates.

FIG. 11 is a flowchart illustrating the subprocess of requesting candidates to individually approve the ballot proof.

FIG. 12 is a flowchart illustrating the subprocess of recording the candidate-requested revisions for the ballot proof.

### DETAIL DESCRIPTIONS OF THE INVENTION

All illustrations of the drawings are for the purpose of describing selected versions of the present invention and are not intended to limit the scope of the present invention.

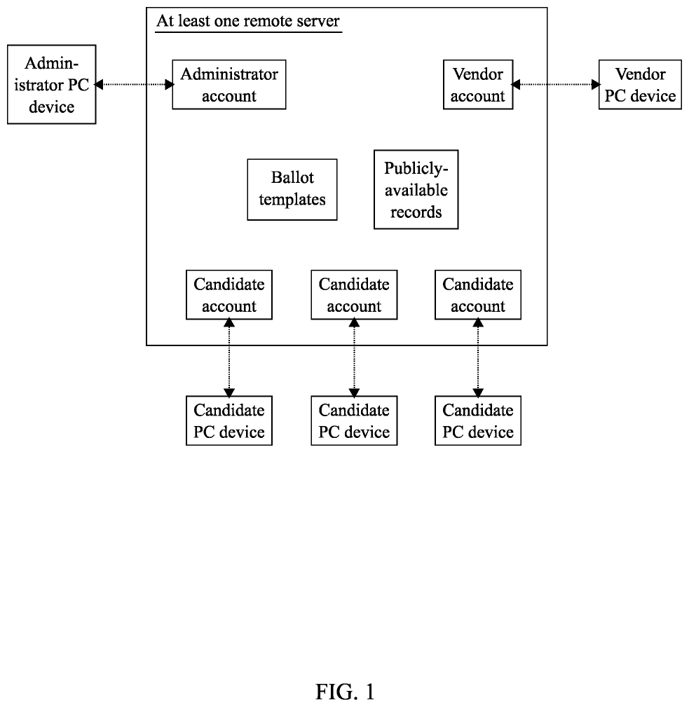

The present invention is a system and a method of editing and proofing an election ballot that automates the ballot proofing process to enable elected officials to be more efficient during the election preparation process. As can be seen in FIG. 1, the system of the present invention includes at least one administrator account managed by at least one remote server (Step A). The administrator account allows elected officials to interact with the system of the present invention in order to supervise the ballot proofing process. In addition, the administrator account is associated with a corresponding administrator personal computing (PC) device. The corresponding administrator PC device can be any computing device with connection to the Internet that allows the elected official to interact with the system of the present invention. For example, the corresponding administrator PC device can include, but is not limited to, desktop computers, laptop computers, computing tablets, smartphones, etc. Furthermore, the system of the present invention includes at least one vendor account managed by the remote server (Step B). The vendor account allows the appropriate ballot vendors to interact with the system of the present invention in order to input requested ballot proofs as well as to receive feedback on the ballot proofs. In addition, the vendor account is also associated with a corresponding vendor PC device. Like the corresponding administrator PC device, the corresponding vendor PC device can be any computing device with connection to the Internet that allows the vendor to interact with the election officials using the system the present invention. For example, the corresponding vendor PC device can include, but is not limited to, desktop computers, laptop computers, computing tablets, smartphones, etc.

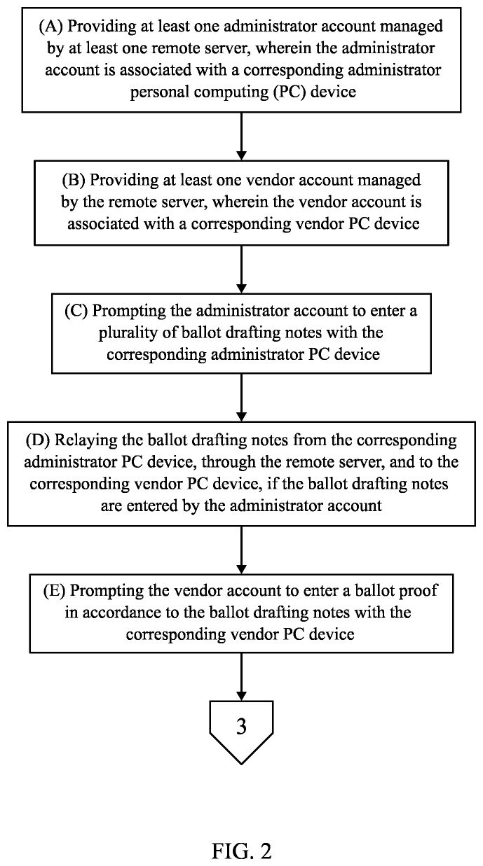

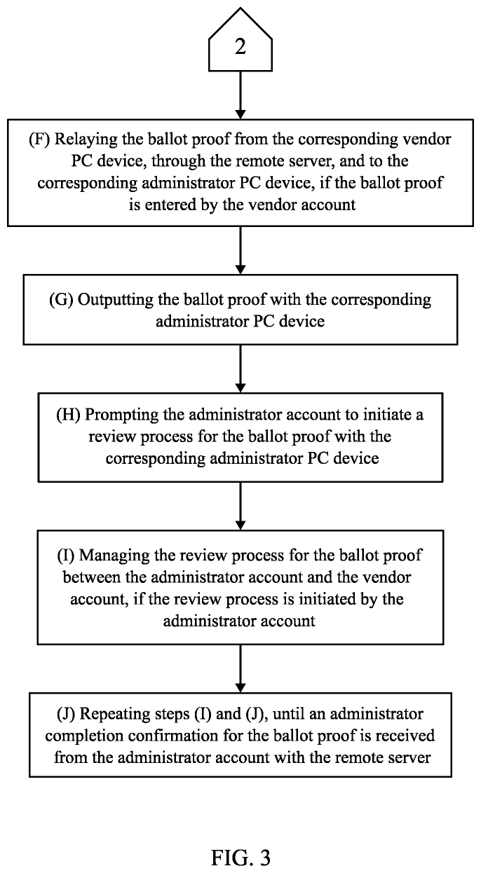

The method of the present invention follows an overall process that optimizes the ballot proofing process by automating the proofing of the ballots for the target election. As can be seen in FIGS. 2 and 3, the overall process begins by prompting the administrator account to enter a plurality of ballot drafting notes with the corresponding administrator PC device (Step C). This step involves election officials to upload precinct data for specific elections. The plurality of ballot drafting notes can include, but is not limited to, races, contests, candidates, questions, polling locations, etc. In addition, the ballot drafting notes can be compiled into a report that clearly and concisely discloses all the information necessary for the generation of a ballot proof. The system of the present invention enables election officials to manage the ballot creation process efficiently administering the precinct and associating data with the corresponding races. This ensures a seamless transition from precinct data to race-specific ballot generation. Once the ballot drafting notes are entered by the appropriate election official, the ballot drafting notes are relayed from the corresponding administrator PC device, through the remote server, and to the corresponding vendor PC device (Step D), if the ballot drafting notes are entered by the administrator account. The appropriate vendors can be notified according to the predetermined communication channels when the ballot drafting notes are sent to the vendor for the generation of a ballot proof. For example, the communication channels can include, but are not limited to, email, text messaging, push notifications, etc. Further, the vendor account is then prompted to enter a ballot proof in accordance to the ballot drafting notes with the corresponding vendor PC device (Step E). The vendor can utilize any proprietary software the vendor prefers to generate the ballot proof which can include, but is not limited to, candidates, questions, instructions for voting, etc. Regardless, information for the ballot proof should match the information on the ballot drafting notes provided by the election officials.

As can be seen in FIGS. 2 and 3, once the ballot proof is generated by the vendor, the ballot proof is then transmitted to the election officials. So, the ballot proof is relayed from the corresponding vendor PC device, through the remote server, and to the corresponding administrator PC device (Step F), if the ballot proof is entered by the vendor account. The ballot proof is transmitted to the election officials for transparency purposes so that the election officials can supervise the automated proofing of the ballot proof generated by the vendor. Further, the ballot proof is outputted with the corresponding administrator PC device (Step G) so that the election officials can supervise the process through the corresponding administrator PC device. Then, the administrator account is prompted to initiate a review process for the ballot proof with the corresponding administrator PC device (Step H). The review process is an automated process performed using an automated algorithm that parses and scans data to compare information that was disclosed on the ballot proof. The review process ensures all data is present and spelled correctly. For example, the review process can utilize machine learning to ensure that the number of write-in lines match the “vote for phrase” (i.e., if a race is a Vote for Two, there should be two write-in lines). Likewise, the review process can review the ballot proof to ensure that a ballot shows up for each precinct (voting location) that was requested on the ballot drafting notes. Further, the review process is managed for the ballot proof between the administrator account and the vendor account (Step I), if the review process is initiated by the administrator account. In other words, if errors are found, election officials can print a report and send the report back to vendor for corrections. Furthermore, Steps H and I are repeated until an administrator completion confirmation for the ballot proof is received from the administrator account with the remote server (Step J). The administrator completion confirmation can include, but is not limited to, documentation showing the approval of the ballot proof by the election officials and other appropriate parties. In other words, the review process and the vendor corrections are repeated until the ballot proof is reviewed, and no error is found by the automated review process.

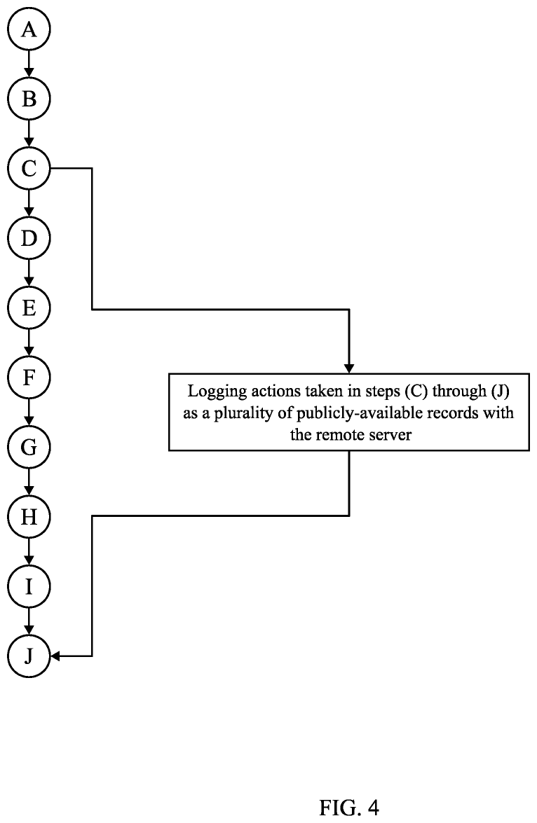

In addition to streamlining the ballot proofing process, the system of the present invention is designed to keep a record of all proofing attempts which can be archived for future auditing. As can be seen in FIG. 4, the subprocess of recording the tasks performed during the automated ballot proof review includes the step of logging actions taken in Steps C through J as a plurality of publicly-available records with the remote server. This way, the ballot proofing process performed using the present invention is recorded for transparency and legal purposes. Appropriate protocols required by the local governments can be implemented to ensure the present invention meets local requirements.

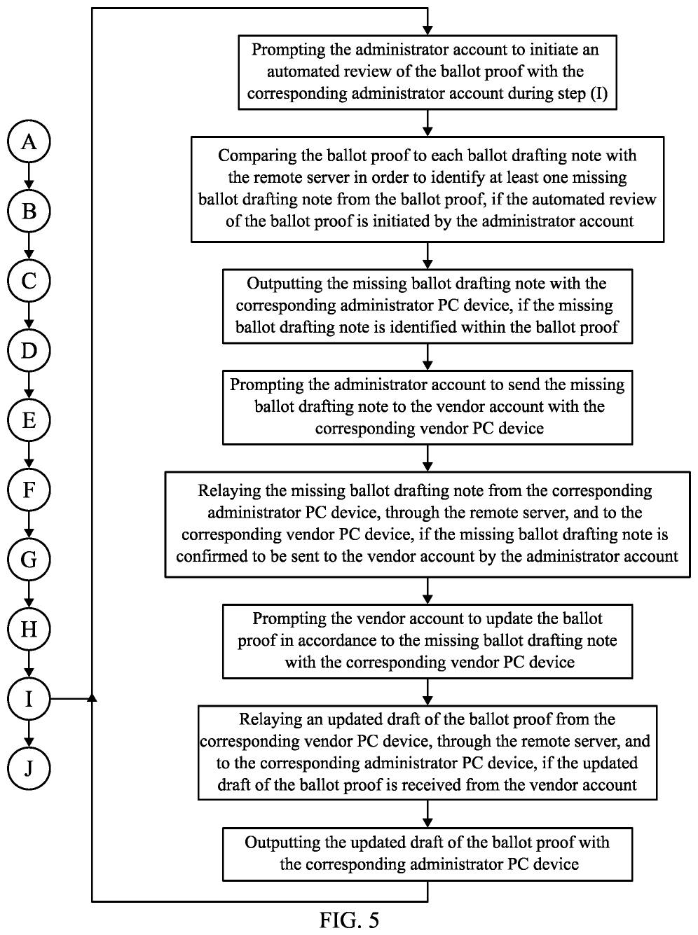

As previously discussed, the present invention enables the vendor to perform the necessary corrections in order to generate a ballot proof that matches the information requested by the elected officials. As can be seen in FIG. 5, the subprocess of requesting updated ballot proofs to fix errors found by the automated review process includes the steps of prompting the administrator account to initiate an automated review of the ballot proof with the corresponding administrator account during Step I. The automated review process can be manually initiated by the election officials or, if necessary, can be automatically performed once the vendor enters the ballot proof into the system of the present invention. Then, the ballot proof is compared to each ballot drafting note with the remote server in order to identify at least one missing ballot drafting note from the ballot proof, if the automated review of the ballot proof is initiated by the administrator account. Machine learning can be implemented to accurately compare the information originally provided on the ballot drafting notes and the information disclosed on the ballot proof in order to eliminate human error. Further, any missing ballot drafting note is outputted with the corresponding administrator PC device, if the missing ballot drafting note is identified within the ballot proof. In order words, if any missing information is detected, either not disclosed or wrongly discussed on the ballot proof, the missing information is compiled by the present invention and the election official is then notified by the present invention. Next, the administrator account is prompted to send the missing ballot drafting note to the vendor account with the corresponding vendor PC device so that the vendor can perform the necessary corrections to the ballot proof. The missing ballot drafting note is relayed from the corresponding administrator PC device, through the remote server, and to the corresponding vendor PC device, if the missing ballot drafting note is confirmed to be sent to the vendor account by the administrator account. This also ensures that the elected officials are always up to date on the review process of the ballot proof. Then, the vendor account is prompted to update the ballot proof in accordance to the missing ballot drafting note with the corresponding vendor PC device. The vendor can perform the necessary corrections using proprietary software before resubmitting the updated ballot proof to the elected officials using the present invention. Next, an updated draft of the ballot proof is relayed from to the corresponding vendor PC device, through the remote server, and the corresponding administrator PC device, if the updated draft of the ballot proof is received from the vendor account. Finally, the updated draft of the ballot proof is outputted with the corresponding administrator PC device so that the elected officials can perform the automated review process to again ensure that the updated ballot proof correctly discloses all the information initially requested on the ballot drafting notes.

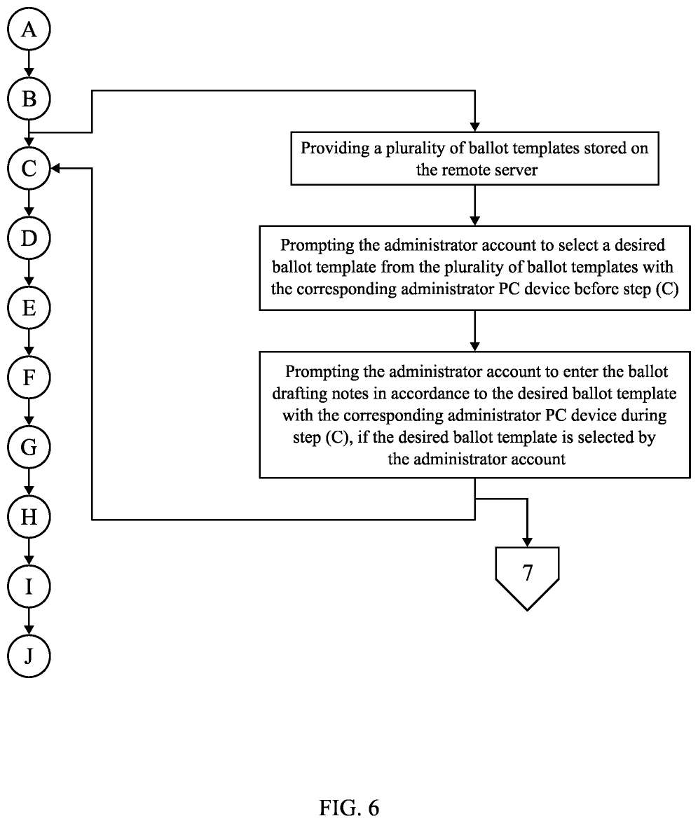

When preparing the ballot drafting notes, the present invention can provide tools to the elected officials to facilitate the input of the ballot information necessary for the generation of the ballot proof. So, the system of the present invention may further include a plurality of ballot templates stored on the remote server. The ballot templates can include, but are not limited to, pre-established templates that guide the elected officials on what ballot information needs to be provided for the generation of the ballot proof. As can be seen in FIG. 6, the subprocess of providing ballot templates to the elected officials includes the steps of prompting the administrator account to select a desired ballot template from the plurality of ballot templates with the corresponding administrator PC device before Step C. A proprietary User Interface (UI) can be provided by the present invention in the form of a software application that enables the elected officials to easily navigate and select the necessary ballot templates. The software application can be developed to be compatible with the corresponding administrator PC device in the form of, but not limited to, a desktop application, cloud application, mobile application, etc. Then, the administrator account is prompted to enter the ballot drafting notes in accordance to the desired ballot template with the corresponding administrator PC device during Step C, if the desired ballot template is selected by the administrator account. This way, the elected officials can properly enter all the necessary information for the generation of the ballot proof.

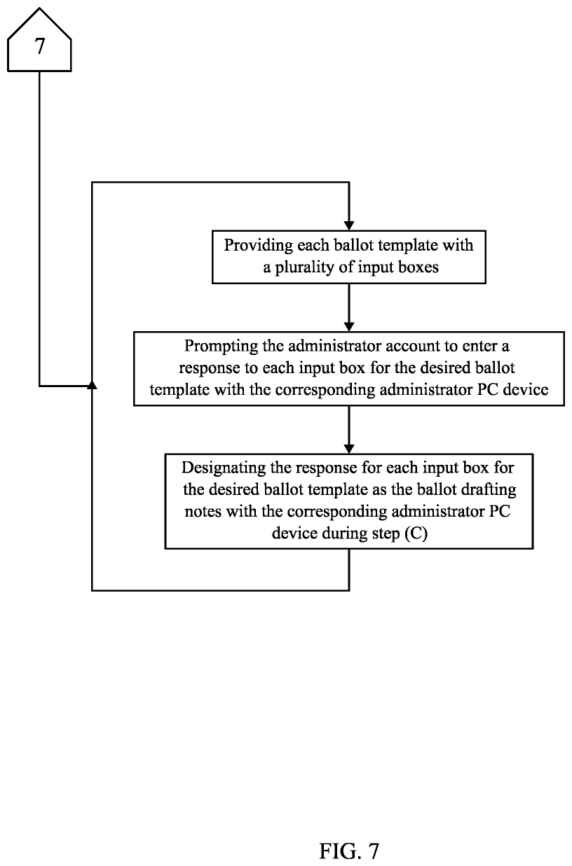

In some embodiments, the ballot templates provided on the remote server can be designed to guide the elected officials through the input process of the ballot information needed for the generation of the ballot proof. To do so, the system of the present invention can provide each ballot template with a plurality of input boxes that prompts the elected officials to enter specific ballot information. The input boxes include data fields visually displayed on the corresponding administrator PC device that show the election officials what data needs to be inputted at the correct locations. As can be seen in FIG. 7, the subprocess of guiding the completion of a ballot template with input boxes includes the steps of prompting the administrator account to enter a response to each input box for the desired ballot template with the corresponding administrator PC device. In other words, on the corresponding UI displayed by the corresponding administrator PC device, the election officials are presented with input boxes that indicate the elected officials what ballot information is entered. Further, the response for each input box for the desired ballot template is designated as the ballot drafting notes with the corresponding administrator PC device during Step C which is relayed to the vendor for the generation of the ballot proof.

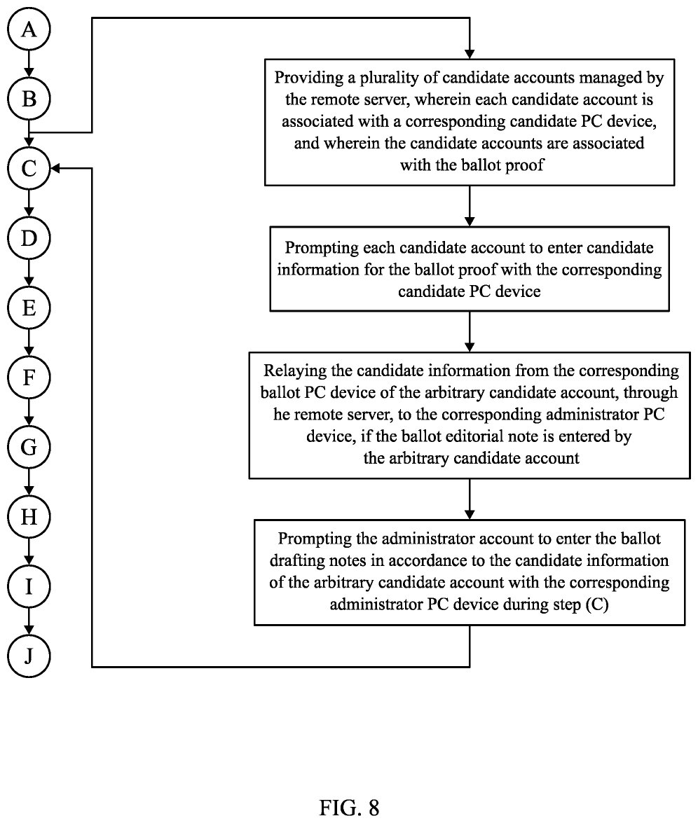

In some embodiments, the present invention enables participating candidates in specific elections to provide the necessary information that is going to be presented on the election ballot. To do so, the system of the present invention includes a plurality of candidate accounts managed by the remote server. The candidate accounts enable the participating candidates to have appropriate access to the system of the present invention. Candidates can be officially invited to register by election officials through the system of the present invention via predetermined communication channels including, but not limited to, email, text messaging, etc. In addition, each candidate account is associated with a corresponding candidate PC device. Similar to the corresponding administrator PC device or the corresponding vendor PC device, the corresponding candidate PC device can be any computing device with connection to the Internet that allows the candidate to interact with the system of the present invention. Further, an official candidate PC device can be provided through which the candidates can interact with the system of the present invention. For example, the election officials can provide an official kiosk accessible to the candidates to improve the security and transparency of the election preparation efforts. Further, the candidate accounts are associated with the ballot proof so that only participating candidates in a specific election can be involved in the corresponding ballot proofing process. However, election officials can retain the option to edit or remove candidate information as necessary. As can be seen in FIG. 8, the subprocess of involving the candidates in the ballot proofing includes the steps of prompting each candidate account to enter candidate information for the ballot proof with the corresponding candidate PC device. The candidate information can include, but is not limited to, candidate name, contact information, race, etc. This way, each candidate can provide the necessary information that needs to be displayed on the election ballot according to the local government's laws. Any necessary documentation can also be submitted via the corresponding candidate PC device. Further, the candidate information is then relayed from the corresponding ballot PC device of the arbitrary candidate account, through the remote server, to the corresponding administrator PC device, if the ballot editorial note is entered by the arbitrary candidate account. This way, the candidate information is securely stored so that only election officials can have access to the candidate information. Furthermore, when the time comes to collect the ballot information necessary for the generation of the ballot proof, the administrator account is prompted to enter the ballot drafting notes in accordance to the candidate information of the arbitrary candidate account with the corresponding administrator PC device during Step C. This way, the election officials can more easily and accurately compile the ballot information necessary for the generation of the ballot proof.

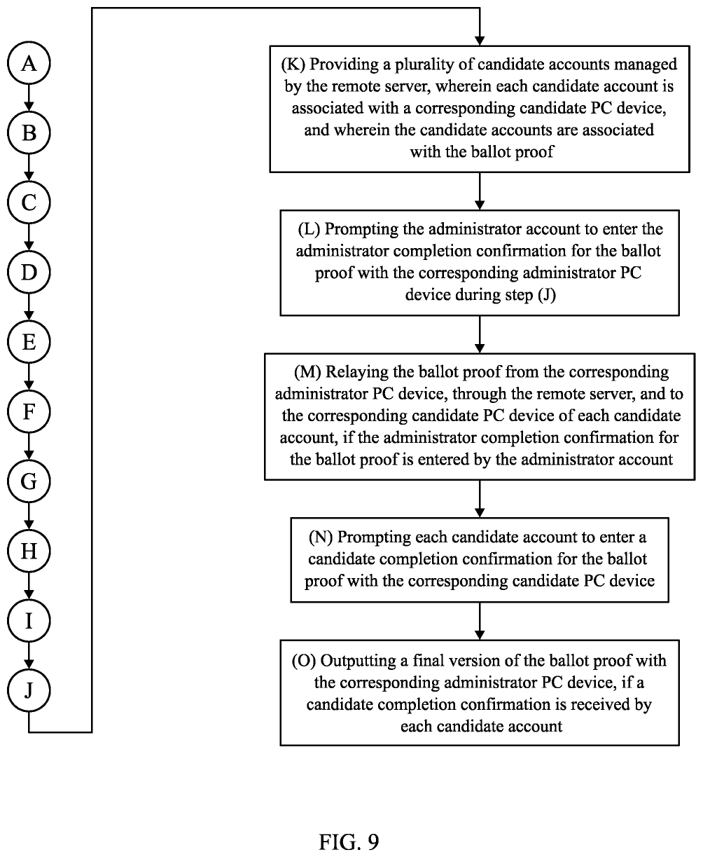

As previously discussed, the present invention also enables candidates participating in the corresponding election to perform personal review of the ballot proofs to increase the transparency and accuracy of the ballot proofing process. To do so, the system of the present invention includes a plurality of candidate accounts managed by the remote server (Step K). The candidate accounts enable the participating candidates to have appropriate access to the system of the present invention to review the ballot proof. As can be seen in FIG. 9, the subprocess of including the appropriate candidates in the ballot proofing includes the steps of prompting the administrator account to enter the administrator completion confirmation for the ballot proof with the corresponding administrator PC device during Step J (Step L). In other words, the election officials confirm that a ballot proof is ready for review by the appropriate candidates after performing the necessary automated review process for the ballot proof. Then, the ballot proof is relayed from the corresponding administrator PC device, through the remote server, and to the corresponding candidate PC device of each candidate account (Step M), if the administrator completion confirmation for the ballot proof is entered by the administrator account. The appropriate candidates can be notified via predetermined communication channels so the candidates can perform the individual ballot proof review. For example, the communication channels can include, but are not limited to, email, text messaging, push notifications, etc. Next, each candidate account is prompted to enter a candidate completion confirmation for the ballot proof with the corresponding candidate PC device (Step N) so that the appropriate candidates can give a personal approval for transparency and legal purposes. Further, a final version of the ballot proof is then output with the corresponding administrator PC device (Step 0), if a candidate completion confirmation is received by each candidate account. Thus, participating candidates can personally ensure that the election ballots display the candidate information correctly.

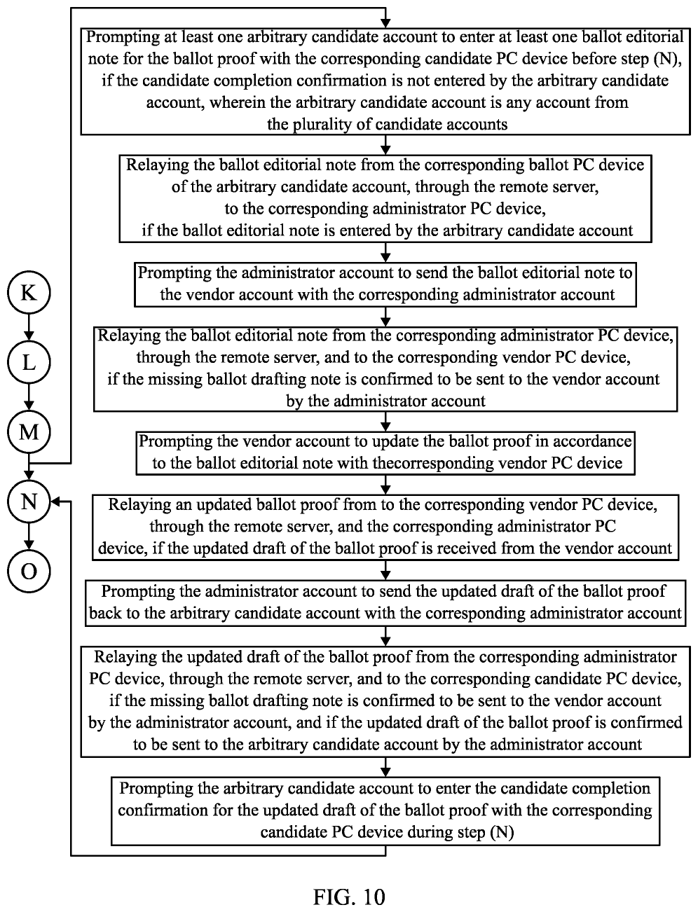

In the event that a candidate finds an error on the ballot proof, the system of the present invention can enable the candidate to request corrections from the election officials. As can be seen in FIG. 10, the subprocess of requesting ballot corrections by the candidates includes the steps of prompting at least one arbitrary candidate account to enter at least one ballot editorial note for the ballot proof with the corresponding candidate PC device before Step N, if the candidate completion confirmation is not entered by the arbitrary candidate account. In other words, if the candidate finds any errors on the ballot proof, the candidate can enter a request for the election officials to correct the ballot proof. In addition, the arbitrary candidate account is any account from the plurality of candidate accounts so that any participating candidate can request a fix to the ballot proof. Then, the ballot editorial note is relayed from the corresponding ballot PC device of the arbitrary candidate account, through the remote server, and to the corresponding administrator PC device, if the ballot editorial note is entered by the arbitrary candidate account. The election officials are notified of the request so that the election officials can send the appropriate request to the vendors to fix the ballot proof. Thus, the administrator account is prompted to send the ballot editorial note to the vendor account with the corresponding administrator account. Then, the ballot editorial note is relayed from the corresponding administrator PC device, through the remote server, and to the corresponding vendor PC device, if the missing ballot drafting note is confirmed to be sent to the vendor account by the administrator account. The vendor can then be notified to perform the necessary corrections based on the ballot editorial note from the candidates. Then, the vendor account is prompted to update the ballot proof in accordance to the ballot editorial note with the corresponding vendor PC device in order to obtain a new ballot proof with the necessary corrections. Further, an updated ballot proof is relayed from to the corresponding vendor PC device, through the remote server, and the corresponding administrator PC device, if the updated draft of the ballot proof is received from the vendor account. Once the election officials receive the updated ballot proof, the administrator account is prompted to send the updated draft of the ballot proof back to the arbitrary candidate account with the corresponding administrator account so that the appropriate candidates can perform a second review of the updated ballot proof. Thus, the updated draft of the ballot proof is relayed from the corresponding administrator PC device, through the remote server, and to the corresponding candidate PC device, if the missing ballot drafting note is confirmed to be sent to the vendor account by the administrator account, and if the updated draft of the ballot proof is confirmed to be sent to the arbitrary candidate account by the administrator account. The appropriate candidates can then be notified so that the arbitrary candidate account is prompted to enter the candidate completion confirmation for the updated draft of the ballot proof with the corresponding candidate PC device during Step N. Thus, candidates can ensure that the candidate information is properly disclosed on the election ballots.

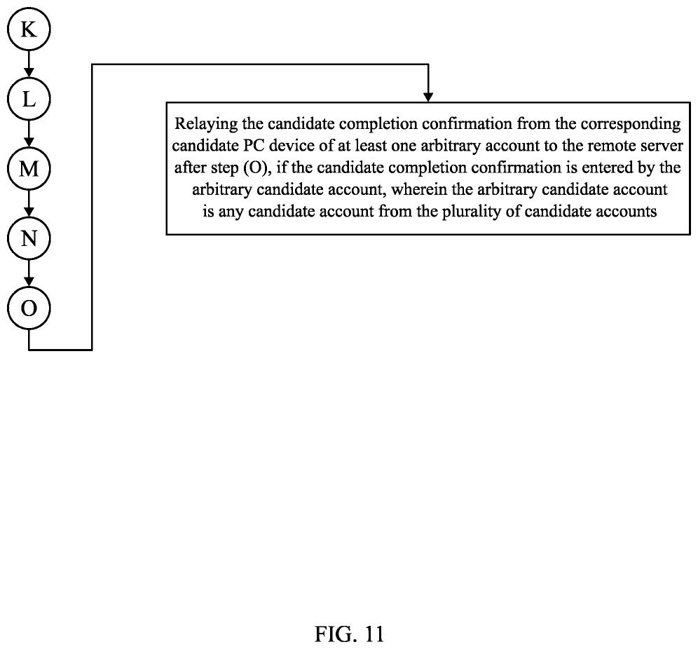

Alternatively, if the candidate finds no error on the ballot proof, the candidate can sign off on the ballot proof to provide the election officials with the documentation necessary to finalize the ballot proofing process. As can be seen in FIG. 11, the subprocess of requesting candidates to individually approve the ballot proof includes the step of relaying the candidate completion confirmation from the corresponding candidate PC device of at least one arbitrary account to the remote server after Step 0, if the candidate completion confirmation is entered by the arbitrary candidate account. In other words, an individual approval for each candidate can be obtained using the present invention to ensure that all candidates participating in a specific election have reviewed the ballot proof. Further, third-party services can be utilized to generate the documentation necessary for proof of approval by the participating candidates in the specific elections. In other embodiments, additional proofing features can be provided that enhance the election preparation process for election officials including, but not limited to, implementing predictive analytics to manage ballot errors, chat options between parties involved in the ballot proofing process, consolidation of ballots (i.e., sample ballot to show all contests on a ballot), generation of newsletters, integration with government systems or vendor systems, or enabling other independent organizations to review documents.

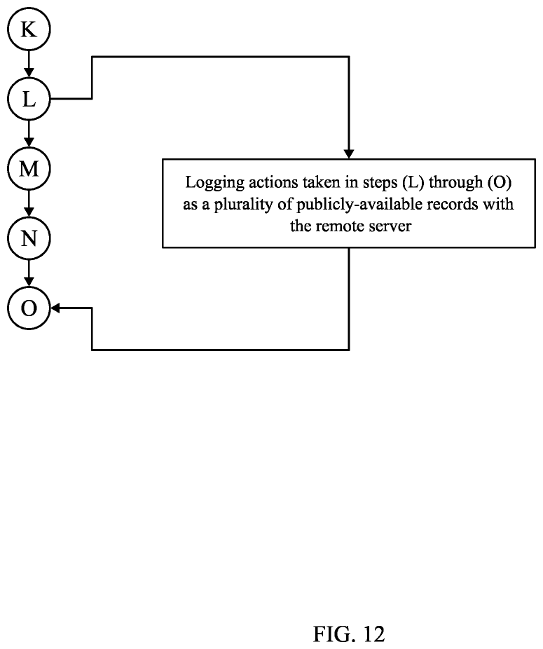

Furthermore, as disclosed before, all revisions performed on the ballot proof are recorded for transparency and to meet local government rules. As can be seen in FIG. 12, the subprocess of recording the candidate-requested revisions for the ballot proof includes the step of logging actions taken in Steps L through O as a plurality of publicly-available records with the remote server. This way, the ballot proofing process including revisions requested by the participating candidates performed using the present invention are recorded for transparency and legal purposes. Appropriate protocols required by the local governments can be implemented to ensure the present invention meets local requirements.

Although the invention has been explained in relation to its preferred embodiment, it is to be understood that many other possible modifications and variations can be made without departing from the spirit and scope of the invention.

What is claimed is:

1. A method of editing and proofing an election ballot, the method comprising the steps of:
(A) providing at least one administrator account managed by at least one remote server, wherein the administrator account is associated with a corresponding administrator personal computing (PC) device;
(B) providing at least one vendor account managed by the remote server, wherein the vendor account is associated with a corresponding vendor PC device;
(C) prompting the administrator account to enter a plurality of ballot drafting notes with the corresponding administrator PC device;
(D) relaying the ballot drafting notes from the corresponding administrator PC device, through the remote server, and to the corresponding vendor PC device, if the ballot drafting notes are entered by the administrator account;
(E) prompting the vendor account to enter a ballot proof in accordance to the ballot drafting notes with the corresponding vendor PC device;
(F) relaying the ballot proof from the corresponding vendor PC device, through the remote server, and to the corresponding administrator PC device, if the ballot proof is entered by the vendor account;
(G) outputting the ballot proof with the corresponding administrator PC device;
(H) prompting the administrator account to initiate a review process for the ballot proof with the corresponding administrator device;
(I) managing the review process for the ballot proof between the administrator account and the vendor account, if the review process is initiated by the administrator account; and
(J) repeating steps (H) and (I), until an administrator completion confirmation for the ballot proof is received from the administrator account with the remote server.

2. The method as claimed in claim 1 comprising the step of:
logging actions taken in steps (C) through (J) as a plurality of publicly-available records with the remote server.

3. The method as claimed in claim 1 comprising the steps of:
prompting the administrator account to initiate an automated review of the ballot proof with the corresponding administrator account during step (I);
comparing the ballot proof to each ballot drafting note with the remote server in order to identify at least one missing ballot drafting note from the ballot proof, if the automated review of the ballot proof is initiated by the administrator account;
outputting the missing ballot drafting note with the corresponding administrator PC device, if the missing ballot drafting note is identified within the ballot proof;
prompting the administrator account to send the missing ballot drafting note to the vendor account with the corresponding vendor PC device;
relaying the missing ballot drafting note from the corresponding administrator PC device, through the remote server, and to the corresponding vendor PC device, if the missing ballot drafting note is confirmed to be sent to the vendor account by the administrator account;
prompting the vendor account to update the ballot proof in accordance to the missing ballot drafting note with the corresponding vendor PC device;
relaying an updated draft of the ballot proof from to the corresponding vendor PC device, through the remote server, and the corresponding administrator PC device, if the updated draft of the ballot proof is received from the vendor account; and
outputting the updated draft of the ballot proof with the corresponding administrator PC device.

4. The method as claimed in claim 1 comprising the steps of:
providing a plurality of ballot templates stored on the remote server;
prompting the administrator account to select a desired ballot template from the plurality of ballot templates with the corresponding administrator PC device before step (C); and
prompting the administrator account to enter the ballot drafting notes in accordance to the desired ballot template with the corresponding administrator PC device during step (C), if the desired ballot template is selected by the administrator account.

5. The method as claimed in claim 4 comprising the steps of:
providing each ballot template with a plurality of input boxes;
prompting the administrator account to enter a response to each input box for the desired ballot template with the corresponding administrator PC device; and
designating the response for each input box for the desired ballot template as the ballot drafting notes with the corresponding administrator PC device during step (C).

6. The method as claimed in claim 1 comprising the steps of:
providing a plurality of candidate accounts managed by the remote server, wherein each candidate account is associated with a corresponding candidate PC device, and wherein the candidate accounts are associated with the ballot proof;
prompting each candidate account to enter candidate information for the ballot proof with the corresponding candidate PC device;
relaying the candidate information from the corresponding ballot PC device of the arbitrary candidate account, through the remote server, to the corresponding administrator PC device, if the ballot editorial note is entered by the arbitrary candidate account; and
prompting the administrator account to enter the ballot drafting notes in accordance to the candidate information of the arbitrary candidate account with the corresponding administrator PC device during step (C).

7. The method as claimed in claim 1 comprising the steps of:
(K) providing a plurality of candidate accounts managed by the remote server, wherein each candidate account is associated with a corresponding candidate PC device, and wherein the candidate accounts are associated with the ballot proof;
(L) prompting the administrator account to enter the administrator completion confirmation for the ballot proof with the corresponding administrator PC device during step (J);
(M) relaying the ballot proof from the corresponding administrator PC device, through the remote server, and to the corresponding candidate PC device of each candidate account, if the administrator completion confirmation for the ballot proof is entered by the administrator account;
(N) prompting each candidate account to enter a candidate completion confirmation for the ballot proof with the corresponding candidate PC device; and
(O) outputting a final version of the ballot proof with the corresponding administrator PC device, if a candidate completion confirmation is received by each candidate account.

8. The method as claimed in claim 7 comprising the steps of:
prompting at least one arbitrary candidate account to enter at least one ballot editorial note for the ballot proof with the corresponding candidate PC device before step (N), if the candidate completion confirmation is not entered by the arbitrary candidate account, wherein the arbitrary candidate account is any account from the plurality of candidate accounts;
relaying the ballot editorial note from the corresponding ballot PC device of the arbitrary candidate account, through the remote server, to the corresponding administrator PC device, if the ballot editorial note is entered by the arbitrary candidate account;
prompting the administrator account to send the ballot editorial note to the vendor account with the corresponding administrator account;
relaying the ballot editorial note from the corresponding administrator PC device, through the remote server, and to the corresponding vendor PC device, if the missing ballot drafting note is confirmed to be sent to the vendor account by the administrator account;
prompting the vendor account to update the ballot proof in accordance to the ballot editorial note with the corresponding vendor PC device;
relaying an updated ballot proof from the corresponding vendor PC device, through the remote server, and to the corresponding administrator PC device, if the updated draft of the ballot proof is received from the vendor account;
prompting the administrator account to send the updated draft of the ballot proof back to the arbitrary candidate account with the corresponding administrator account;
relaying the updated draft of the ballot proof from the corresponding administrator PC device, through the remote server, and to the corresponding candidate PC device, if the missing ballot drafting note is confirmed to be sent to the vendor account by the administrator account, and if the updated draft of the ballot proof is confirmed to be sent to the arbitrary candidate account by the administrator account; and
prompting the arbitrary candidate account to enter the candidate completion confirmation for the updated draft of the ballot proof with the corresponding candidate PC device during step (N).

9. The method as claimed in claim 7 comprising the steps of:
relaying the candidate completion confirmation from the corresponding candidate PC device of at least one arbitrary candidate account to the remote server after step (O), if the candidate completion confirmation is entered by the arbitrary candidate account, wherein the arbitrary candidate account is any candidate account from the plurality of candidate accounts.

10. The method as claimed in claim 7 comprising the step of:
logging actions taken in steps (L) through (O) as a plurality of publicly-available records with the remote server.
